(19) United States
(12) Patent Application Publication
(10) Pub. No.: US 2017/0168192 A1
(43) Pub. Date: Jun. 15, 2017

(54) SCINTILLATION MATERIALS OPTIMIZATION IN SPECTROMETRIC DETECTORS FOR DOWNHOLE NUCLEAR LOGGING WITH PULSED NEUTRON GENERATOR BASED TOOLS

(71) Applicant: BAKER HUGHES INCORPORATED, Houston, TX (US)

(72) Inventors: Maxim VASILYEV, The Woodlands, TX (US); Toyli ANNIYEV, The Woodlands, TX (US); Bair V. BANZAROV, Novosibirsk (RU); Steven M. Bliven, Houston, TX (US); Feyzi INANC, Spring, TX (US); Alexandr A. VINOKUROV, Novosibirsk (RU)

(73) Assignee: BAKER HUGHES INCORPORATED, Houston, TX (US)

(21) Appl. No.: 14/968,437

(22) Filed: Dec. 14, 2015

(51) Int. Cl. G01V 5/10; G01T 1/20

(52) U.S. Cl. CPC G01V 5/102; G01T 1/20

(57) ABSTRACT

Methods, systems, and devices for evaluating an earth formation intersected by a borehole. Methods may include irradiating the earth formation using a radiation source to provoke radiation from the formation responsive to the irradiation; taking a radiation measurement and thereby generating radiation measurement information by producing light scintillations from a scintillation material responsive to the absorption by the scintillation material of the radiation from the formation and substantial intrinsic radiation of the scintillation material; and estimating a parameter of interest of the earth formation using the radiation measurement information.

### FIELD OF THE DISCLOSURE

This disclosure generally relates to borehole logging methods and apparatuses for estimating formation properties using nuclear radiation based measurements.

### BACKGROUND OF THE DISCLOSURE

Oil well logging has been known for many years and provides an oil and gas well driller with information about the particular earth formation being drilled. In conventional oil well logging, during well drilling and/or after a well has been drilled, a nuclear radiation source and associated nuclear radiation detectors may be conveyed into the borehole and used to determine one or more parameters of interest of the formation. A rigid or non-rigid conveyance device is often used to convey the nuclear radiation source, often as part of a tool or a set of tools, and the carrier may also provide communication channels for sending information up to the surface.

### SUMMARY OF THE DISCLOSURE

In aspects, this disclosure relates to evaluation of an earth formation using radiation from the formation. The radiation may be induced by neutron irradiation. In some aspects, this disclosure relates to estimating a parameter of interest related to the formation.

Methods for estimating parameters of interest may include the acquiring and utilization of information characterizing radiation from the formation responsive to irradiation by the apparatus. The information may be acquired by tools deployed into a wellbore intersecting one or more volumes of interest of an earth formation. The acquired radiation measurement information may be then be processed to estimate parameters of interest of the formation, which are then used to better conduct further exploration, development, and production operations in the formation.

General method embodiments may include irradiating the earth formation using a radiation source to provoke radiation from the formation responsive to the irradiation; taking a radiation measurement and thereby generating radiation measurement information by producing light scintillations from a scintillation material responsive to the absorption by the scintillation material of the radiation from the formation and substantial intrinsic radiation of the scintillation material; and estimating a parameter of interest of the earth formation using the radiation measurement information. The scintillation material may comprise at least one of: i) Lu₃Al₅O₁₂:Pr (LuAG:Pr), and ii) Lu₂₍₁₋ₓ₎Y₂SiO₅:Ce (LYSO).

Irradiating the earth formation may comprise using a pulsed neutron source. Measuring the radiation may comprise measuring gamma rays resulting from the irradiation. The radiation measurement information may be non-adjusted. The radiation measurement information may be modified using a correction heuristic, and the correction heuristic is predetermined prior to the taking of the radiation measurement. The radiation measurement information may be modified using a correction heuristic, and the correction heuristic is independent of the portion of the radiation measurement information attributable to intrinsic radiation of the scintillation material.

Methods may include deriving a response spectrum from the radiation measurement information and using the response spectrum to estimate the parameter of interest. The parameter of interest may include at least one of: (i) a lithology characterization; (ii) a mineralogical composition; (iii) a carbon-oxygen ratio; (iv) neutron capture cross-section of the formation; (v) a sourceless gamma density estimate. Irradiating the earth formation may result in oxygen activation, and the radiation measurement information may be indicative of oxygen activation. Methods may include conveying the source of radiation into the borehole on a conveyance device selected from: (i) a wireline, and (ii) a bottomhole assembly on a drilling tubular.

Other methods may include evaluating an earth formation intersected by a borehole. Methods may include irradiating the earth formation using a radiation source to provoke radiation from the formation responsive to the irradiation; taking a radiation measurement and thereby generating radiation measurement information by producing light scintillations from a lutetium-based scintillation material responsive to the absorption by the scintillation material of the radiation from the formation and intrinsic radiation of the scintillation material, wherein the intrinsic radiation of the scintillation material produces at least 100 scintillations per second per cubic centimeter of the material; and estimating a parameter of interest of the earth formation using the radiation measurement information.

Apparatus embodiments for evaluating an earth formation intersected by a borehole in accordance with the present disclosure may include a carrier configured to be conveyed in a borehole; a radiation source associated with the carrier and configured for irradiating the earth formation to provoke radiation from the formation responsive to the irradiation; a radiation detector associated with the carrier and configured for taking a radiation measurement in the borehole and thereby generating radiation measurement information by producing light scintillations from a scintillation material responsive to the absorption by the scintillation material of the radiation from the formation and intrinsic radiation of the scintillation material, the scintillation material comprising at least one of: i) Lu₃Al₅O₁₂:Pr (LuAG:Pr), and ii) Lu₂₍₁₋ₓ₎Y₂SiO₅:Ce (LYSO); and at least one processor configured for estimating a parameter of interest of the earth formation using the radiation measurement information. Some embodiments include a non-transitory computer-readable medium product accessible to the processor and having instructions thereon that, when executed, causes the at least one processor to perform methods described above.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1A schematically illustrates a system having a downhole tool configured to acquire information in a borehole intersecting a volume of interest of an earth formation.

FIG. 1B illustrates radiation interactions in the formation in accordance with embodiments of the present disclosure.

FIGS. 2A and 2B illustrate a detection system in accordance with embodiments of the present disclosure.

FIG. 3 illustrates an example response spectrum in accordance with embodiments of the present disclosure.

FIG. 4 is a graphical representation of scintillator energy resolution with respect to light yield in accordance with embodiments of the present disclosure.

FIG. 5 shows relative pulse height for each measured detector with respect to environmental temperature in accordance with embodiments of the present disclosure.

FIG. 6 shows energy resolution dependence on environmental temperature for detectors with various scintillators in accordance with embodiments of the present disclosure.

FIG. 7 illustrates energy spectra measured with one-inch diameter, six-inch long LYSO crystal in a synthetic formation irradiated with PNG for different ambient temperatures in accordance with embodiments of the present disclosure.

FIG. 8 shows a standard deviation in various element concentrations for detectors having one-inch diameters at a temperature of 100 Celsius.

FIG. 9 shows a standard deviation in various element concentrations for detectors having two-inch diameters at a temperature of 100 Celsius.

FIG. 10 shows a standard deviation in various element concentrations for detectors having three-inch diameters at a temperature of 100 Celsius.

FIG. 11 shows a standard deviation in various element concentrations for detectors having one-inch diameters at a temperature of 175 Celsius.

FIG. 12 shows a standard deviation in various element concentrations for detectors having two-inch diameters at a temperature of 175 Celsius.

FIG. 13 shows a standard deviation in various element concentrations for detectors having three-inch diameters at a temperature of 175 Celsius.

FIG. 14 shows the spectral distribution of irradiated crystals in accordance with embodiment of the present disclosure.

FIG. 15 shows a flow chart for estimating at least one parameter of interest of the earth formation in accordance with embodiments of the present disclosure.

FIG. 16 illustrates an example drilling system using a detector with scintillation material in accordance with embodiments of the present disclosure.

### DETAILED DESCRIPTION

In aspects, this disclosure relates to evaluation of a volume of interest of an earth formation using radiation induced by neutron irradiation. In some aspects, this disclosure relates to estimating a parameter of interest related to the volume.

Illustrative methods for estimating parameters of interest may include the acquiring and utilization of information characterizing radiation from the formation responsive to irradiation by the apparatus. The information may be acquired by tools deployed into a wellbore intersecting one or more volumes of interest of an earth formation. The radiation (e.g., thermal, epithermal, or other neutrons, gamma rays, etc.) may be detected at one or more detectors on these tools in the borehole. In some aspects, this disclosure relates to logging in real time in a measurement-while-drilling (MWD) tool. For context, an exemplary system for deploying and using such tools to acquire this information is described below. The acquired radiation measurement information may be then be processed to estimate parameters of interest of the formation, which are then used to better conduct further exploration, development, and production operations in the formation. Each of these aspects may be referred to generally as investigation of the formation.

General method embodiments may include irradiating the earth formation using a radiation source to provoke radiation from the formation responsive to the irradiation; taking a radiation measurement and thereby generating radiation measurement information by producing light scintillations from a scintillation material responsive to the absorption by the scintillation material of the radiation from the formation and substantial intrinsic radiation of the scintillation material; and estimating a parameter of interest of the earth formation using the radiation measurement information.

Scintillation materials are widely used in downhole radiation detectors. The scintillation material emits light scintillations in response to radiation, which may be detected by further instruments optically connected to the material. Typically, the instrumentation provides electrical signals responsive to the detected light scintillations that may be analyzed and used to characterize detected radiation and the earth formation.

Myriad downhole applications exist for the detection of radiation, and new techniques are constantly being discovered. However, design constraints issuing from the inherent properties of available scintillation materials can make particular types of downhole measurement problematic.

Historically, scintillation materials have been developed which have sufficient density and atomic number to provide good detection of incident radiation. For gamma ray detection, particularly, efficiency depends on scintillator density and effective atomic number. Bi₄Ge₃O₁₂ (‘BGO’), as one example, has a density of 7.13 g/cm³ and effective atomic number of 74. However, many traditional scintillation materials suffer from insufficient light yield (‘LY’) and energy resolution. In such cases, the energies of incident radiation fail to provide adequate pulse height. For example, when measuring gamma rays with energies of just few MeV downhole, BGO struggles to provide reasonable LY. The energy resolution of BGO is also a critical shortcoming, which proves particularly disadvantageous in spectrometric applications, which require substantial energy resolution. The temperature behavior of LY (and energy resolution) for BGO is also problematic.

Other common materials, such as the widely-used NaI(Tl), exhibit the reverse problem. NaI(Tl) provides sufficient energy resolution due to a high light output (approximately 38 photons/keV). NaI(Tl) shows very good temperature dependence as well. However, with a density of only 3.67 g/cm3 and effective charge of 51, it is not as efficient as other scintillators.

Many scintillators, including BGO and NaI(Tl), exhibit a further disadvantage: a rather long scintillation decay time (300 ns for BGO, and 230 ns for NaI(Tl)). An extended decay time caps the maximum achievable count rate of the data acquisition system. This property is particularly disadvantageous for BGO because of its excellent efficiency for gamma rays.

For spectrometric tools, particularly, the energy resolution of a scintillator material and its dependence on ambient temperature is an important characteristic. Scintillator efficiency decreases with increasing temperature. Ambient temperatures in the borehole are commonly over 100 degrees and may exceed 200 degrees Celcius. As these temperatures are reached by traditional scintillation materials, pulse height of the scintillations falls dramatically and performance (e.g., energy resolution) of the detector becomes problematic.

Other scintillating materials are known which have sufficient values for many of the above properties, but which exhibit substantial intrinsic radiation. That is, these materials are themselves radioactive and will emit radiation internally. Until this point, it was considered that this intrinsic radiation would spoil the measurement information in gamma ray applications, particularly spectrometric applications.

The present disclosure relates to the use of scintillation materials exhibiting substantial intrinsic radiation. Aspects of the present disclosure include measuring the radiation from the formation (and thereby generating radiation measurement information) by producing light scintillations from a scintillation material responsive to the absorption of the radiation from the formation by the scintillation material, the scintillation material having substantial intrinsic radiation. The scintillation material may comprise at least one of i) LuAG:Pr; and ii) LYSO.

Neither LYSO nor LuAG:Pr scintillators have been used in pulsed neutron tools in the past due to their internal radiation. Despite the high internal radioactivity of these scintillators, their properties in total may be ideal for employment in particular applications. LYSO and LuAG:Pr scintillation materials have many desirable properties: a density comparable with that one of BGO (7.1 g/cm3-LYSO , 6.73 g/cm3-LuAG:Pr and 7.13 g/cm3-BGO), with a much shorter decay time than BGO (LYSO at 41 ns and LuAG:Pr at 20 ns; BGO at 300 ns). Also, high temperature performance for both scintillators is much better than BGO.

Further, through aspects of the present disclosure described in further detail below, it is illustrated that effects of the high internal radioactivity may be sufficiently mitigated to allow use of these materials for particular downhole applications. As one example, LYSO and LuAG:Pr scintillators measure a substantially higher energy region of gamma spectra. As described below, this signature allows for rejection of the internal radiation when using the radiation information obtained using the scintillator. For instance, a 1 MeV energy threshold may be applied to a gamma spectra representative of the radiation information.

Herein, the terms “nuclear radiation” and “radiation emission” include particle and non-particle radiation emitted by atomic nuclei during nuclear processes (such as radioactive decay and/or nuclear bombardment), which may include, but are not limited to, photons from neutron inelastic scattering and from neutron thermal capture reactions, neutrons, electrons, alpha particles, beta particles, and pair production photons.

The formation may be exposed to energy from a radiation source. Downhole tools may include this radiation source and one or more detectors in one or more detector chambers. Herein, the radiation source may include, but is not limited to, a pulsed neutron source. The detectors may be used to detect radiation from the formation, though the detectors are not limited to detecting radiation of the same type as emitted by the radiation source. For example, following neutron irradiation of the earth formation, interactions between the neutrons and nuclides in the formation may produce gamma radiation (e.g., gamma rays) that may be detected by the radiation detectors. The response from the formation may be in the form of prompt and/or delayed nuclear radiation, such as gamma rays from the radioactive decay of the isotopes, and the amount of nuclear radiation may be a function of the amount of radioactive isotopes present.

As one example, application of neutrons may cause “activation” of specific nuclides (e.g., carbon, silicon, and oxygen) that may be found in a downhole environment. The activated nuclides may emit ionizing radiation, such as gamma rays. The term “activation” relates to the conversion of a normally stable nuclide into a radionuclide through a nuclear process, such as, but not limited to, neutron-proton (n,p) reactions and radiative capture (n,γ). Depending on the radionuclide, in some applications the delayed decay spectrum may have characteristics that allow the radionuclide to be used as a nuclear radiation source.

For example, oxygen-16 is irradiated by fast neutrons (over 10 MeV), the interaction of the neutrons with the oxygen-16 nuclide may result in a nitrogen-16 radionuclide which may emit certain gamma rays. In another mode, fast neutrons can inelastically scatter from oxygen-16 nuclei, putting the nuclei in an excited energy state. This may result in a gamma emission so that the nucleus can go back to stable energy state.

If multiple detectors are used, the detectors may be spaced in a substantially linear fashion relative to the radiation source. The detectors may be spaced at different distances from the radiation source. For example, if two detectors are used, there may be a short spaced (SS) detector and a long spaced (LS) detector. The SS and LS detectors are not limited to being placed on the same side of the radiation source as long as their spacing from the radiation source is different. Additional detectors may be used, for example, having differing spacing from the spacing of the other detectors relative to the radiation source. In some implementations, one of the two detectors may be a neutron detector, while the other detector may be a neutron detector or another type of radiation detector, such as, but not limited to, a gamma-ray detector and/or an x-ray detector.

The detectors may detect neutrons and gamma rays emitted by the volume of interest. The radiation information may include multiple components, made up of, for example neutrons, gamma rays, and the like. The components may be detected simultaneously. An algorithm may be used to deconvolve the radiation information into the constituent components.

The components may provide multiple depths of investigation. Since the components may be detected simultaneously using a single detector, the radiation information may be collected over a short period of time, such as a single pulse cycle. Herein, a pulse cycle is defined as the period between the initiation of a first neutron pulse by a neutron source and a second pulse, thus the pulse cycle includes the neutron pulse period and its associated decay period. In one embodiment, the pulse cycle is about 1000 microseconds (e.g., a 60 microsecond pulse period and 940 microsecond decay period).

In some embodiments, porosity and traditional SIGMA for a formation may be estimated. In other embodiments, gamma count may be used to estimate gamma-driven SIGMA measurements for the volume of interest.

The detected nuclear radiation may be expressed as an energy spectrum (the “response spectrum”). The response spectrum may be measured over a wide range of energies, resulting in improved estimation of the parameter of interest. For example, the response spectrum may span a continuous energy range including gamma ray photo peaks at characteristic energies of interest. Alternatively, specific energy windows may be used which are best suited for particular techniques or for estimating particular parameters.

Response spectrum refers to not only the response spectrum as originally acquired, but also after filtering, corrections, or pre-processing is applied. Since the energy spectrum may include energy spectrum components from multiple sources, the nuclear radiation information may be separated to identify the components contained with the energy spectrum. In some embodiments, the processing may include, but is not limited to, use of one or more of: (i) a mathematical equation, (ii) an algorithm, (iii) an energy spectrum deconvolution technique, (iv) a stripping technique, (v) an energy spectrum window technique, (vi) a time spectrum deconvolution technique, and (vii) a time spectrum window technique.

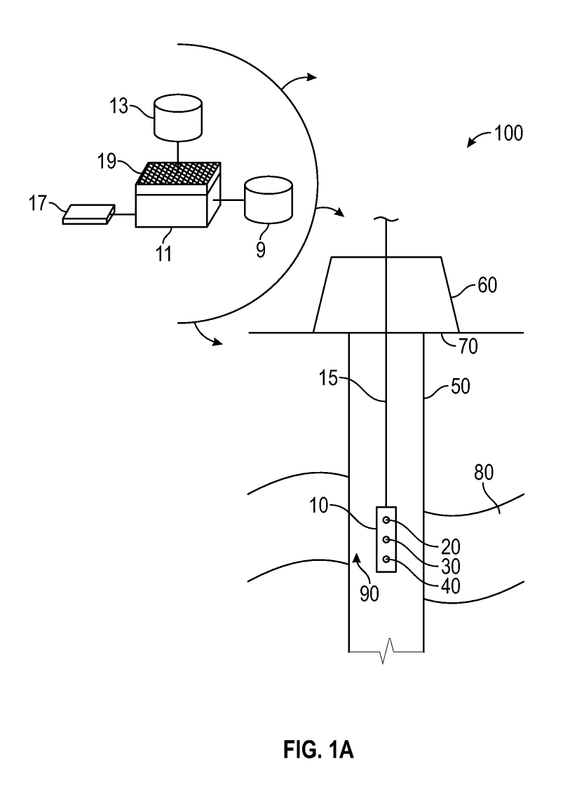

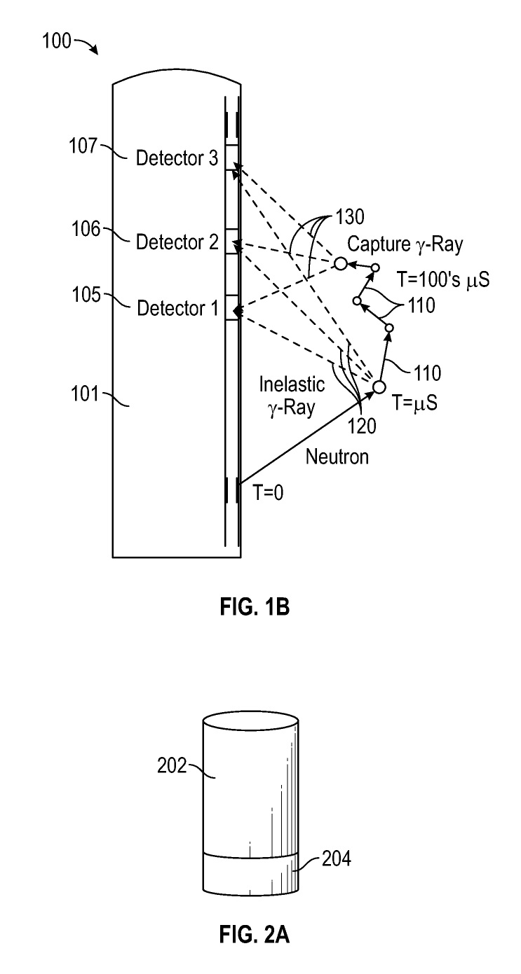

FIG. 1A schematically illustrates a system 100 having a downhole tool 10 configured to acquire information in a borehole 50 intersecting a volume of interest of an earth formation 80 for estimating density, oil saturation, and/or other parameters of interest of the formation 80. The parameters of interest may include information relating to a geological parameter, a geophysical parameter, a petrophysical parameter, and/or a lithological parameter. Thus, the tool 10 may include a sensor array including sensors for detecting physical phenomena indicative of the parameter of interest may include sensors for estimating formation resistivity, dielectric constant, the presence or absence of hydrocarbons, acoustic density, bed boundary, formation density, nuclear density and certain rock characteristics, permeability, capillary pressure, and relative permeability. The tool 10 may include detectors 20, 30 for detecting radiation (e.g., radiation detectors) and a radiation source 40. Detectors 20, 30 may detect radiation from the borehole, the tool, or the formation. In some embodiments, the tool 10 may have more or fewer detectors (or sources).

The system 100 may include a conventional derrick 60 and a conveyance device (or carrier) 15, which may be rigid or non-rigid, and may be configured to convey the downhole tool 10 into wellbore 50 in proximity to formation 80. The carrier 15 may be a drill string, coiled tubing, a slickline, an e-line, a wireline, etc. Downhole tool 10 may be coupled or combined with additional tools. Thus, depending on the configuration, the tool 10 may be used during drilling and/or after the borehole (wellbore) 50 has been formed. While a land system is shown, the teachings of the present disclosure may also be utilized in offshore or subsea applications. The carrier 15 may include embedded conductors for power and/or data for providing signal and/or power communication between the surface and downhole equipment. The carrier 15 may include a bottom hole assembly, which may include a drilling motor for rotating a drill bit.

In some embodiments, the optional radiation source 40 emits radiation (e.g., neutrons) into the formation to be surveyed. In one embodiment, the downhole tool 10 may use a pulsed neutron generator emitting 14.2 MeV fast neutrons as its radiation source 40. The use of 14.2 MeV neutrons from a pulsed neutron source is illustrative and exemplary only, as different energy levels of neutrons may be used. In some embodiments, the radiation source 40 may be continuous. In some embodiments, the radiation source 40 may be controllable in that the radiation source may be turned “on” and “off” while in the wellbore, as opposed to a radiation source that is “on” continuously. The measurements performed using this type of radiation may be referred to as “sourceless” measurements since they employ a source that may be turned off, as opposed to a continuously emitting chemical radiation source.

Due to the intermittent nature of the radiation source, radiation from the source will reach differently spaced detectors at different times. When the radiation source transmits a signal, such as a pulse, the resulting response from the earth formation may arrive at the respective detectors at different times.

Additional detectors may be used to provide additional radiation information. Two or more of the detectors may be gamma ray detectors. Some embodiments may include radiation shielding (not shown). Drilling fluid 90 may be present between the formation 80 and the downhole tool 10, such that radiation may pass through drilling fluid 90 to reach the detectors 20, 30.

Certain embodiments of the present disclosure may be implemented with a hardware environment that includes an information processor 11, an information storage medium 13, an input device 17, processor memory 19, and may include peripheral information storage medium 9. The hardware environment may be in the well, at the rig, or at a remote location. Moreover, the several components of the hardware environment may be distributed among those locations. The input device 17 may be any data reader or user input device, such as data card reader, keyboard, USB port, etc. The information storage medium 13 stores information provided by the detectors. Information storage medium 13 may include any non-transitory computer-readable medium for standard computer information storage, such as a USB drive, memory stick, hard disk, removable RAM, EPROMs, EAROMs, flash memories and optical disks or other commonly used memory storage system known to one of ordinary skill in the art including Internet based storage. Information storage medium 13 stores a program that when executed causes information processor 11 to execute the disclosed method. Information storage medium 13 may also store the formation information provided by the user, or the formation information may be stored in a peripheral information storage medium 9, which may be any standard computer information storage device, such as a USB drive, memory stick, hard disk, removable RAM, or other commonly used memory storage system known to one of ordinary skill in the art including Internet based storage. Information processor 11 may be any form of computer or mathematical processing hardware, including Internet based hardware. When the program is loaded from information storage medium 13 into processor memory 19 (e.g. computer RAM), the program, when executed, causes information processor 11 to retrieve detector information from either information storage medium 13 or peripheral information storage medium 9 and process the information to estimate a parameter of interest. Information processor 11 may be located on the surface or downhole.

The term “information” as used herein includes any form of information (analog, digital, EM, printed, etc.). As used herein, a processor is any information processing device that transmits, receives, manipulates, converts, calculates, modulates, transposes, carries, stores, or otherwise utilizes information. In several non-limiting aspects of the disclosure, a processor includes a computer that executes programmed instructions for performing various methods as described herein. These instructions may provide for equipment operation, control, data collection and analysis, and other functions in addition to the functions described in this disclosure. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on.

In other embodiments, such electronics may be located elsewhere (e.g., at the surface, or remotely). To perform the treatments during a single trip, the tool may use a high bandwidth transmission to transmit the information acquired by detectors 20, 30 to the surface for analysis. For instance, a communication line for transmitting the acquired information may be an optical fiber, a metal conductor, or any other suitable signal conducting medium. It should be appreciated that the use of a “high bandwidth” communication line may allow surface personnel to monitor and control the activity in “real time.”

The short-spaced (SS) detector 30 is closer to the source 40 than the long-spaced (LS) detector 20. Fast neutrons (approximately 14.2 MeV) are emitted from the source 40 and enter the borehole and formation, where they undergo several types of interactions. During the first few microseconds (μs), before they lose much energy, some neutrons are involved in inelastic scattering with nuclei in the borehole and formation and produce gamma rays. These inelastic gamma rays have energies that are characteristic of the atomic nuclei that produced them. The atomic nuclei found in this environment include, for example, carbon, oxygen, silicon, calcium, and some others.

In various embodiments, two or more gamma-ray detectors may be employed in one or more modes of operation. Such modes include, but are not limited to, a pulsed neutron capture mode, a pulsed neutron spectrometry mode, a pulsed neutron imager mode, and a neutron activation mode. In a pulsed neutron capture mode, for example, the pulsed neutron generator may pulse at 1 kHz, and records a complete time spectrum for each detector.

An energy spectrum may also be recorded for maintaining energy discrimination levels. Time spectra from short-spaced and long-spaced detectors can be processed individually to provide traditional thermal neutron capture cross section information, or the two spectra can be used together to automatically correct for borehole and diffusion effects and produce results substantially approximating intrinsic formation values.

In a pulsed neutron spectrometry mode, at least one processor may cause the instrument to pulse at 10 kHz, for example, and record full inelastic and capture gamma ray energy spectra from each detector. The radiation information may be processed to determine elemental ratios including carbon/oxygen and calcium/silicon from the inelastic spectra and silicon/calcium from the capture spectra.

After just a few microseconds, most of the neutrons are slowed by either inelastic or elastic scattering until they reach thermal energies, e.g., at about 0.025 eV. This process is illustrated schematically in FIG. 1B as the sequence of solid arrows 110. At thermal energies, neutrons continue to undergo elastic collisions, but they no longer lose energy on average. A few μs after the neutron generator shuts off, the process of thermalization is complete. Over the next several hundred μs , thermal neutrons are captured by nuclei of various elements—again producing gamma rays, known as capture gamma rays 130. A capture gamma ray energy spectrum yields information about the relative abundances of these elements. The inelastic gamma rays are depicted by 120. These components of radiation are detected by detectors 105-107 of tool 101.

For some applications, it may be sufficient to measure the inelastically scattered gamma rays from the mud. Accordingly, for the limited purposes of the present invention, it may be sufficient to use measurements from only the SS detector.

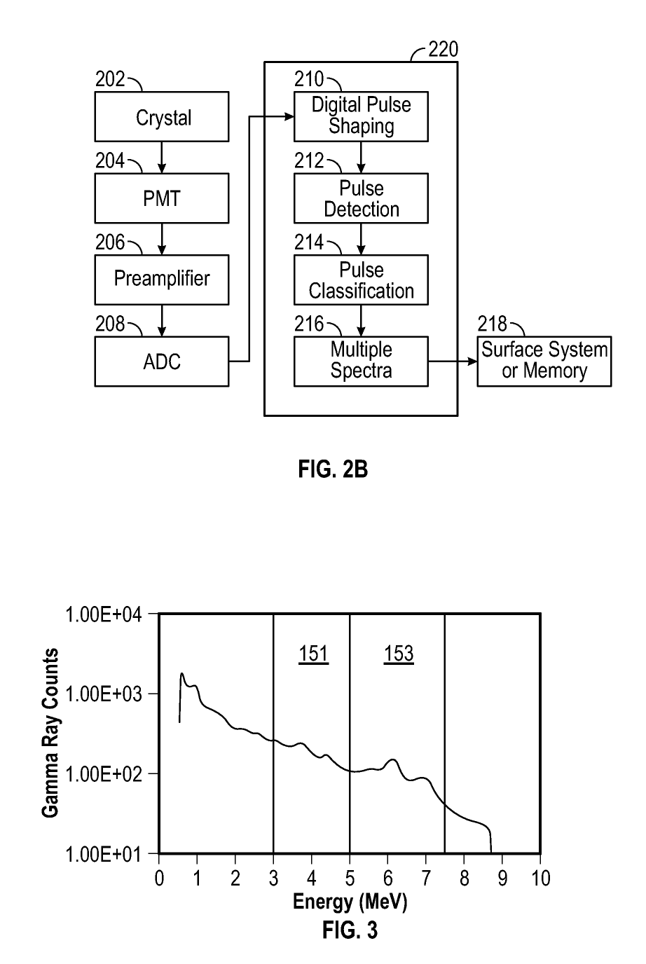

FIGS. 2A and 2B illustrate a detection system in accordance with embodiments of the present disclosure. The system includes a scintillation crystal 202 producing light scintillations responsive to incident radiation. The light interacts with a PMT 204 which produces an analog electrical (e.g., voltage) signal. To deliver a high counting system, crystals with fast decay time constants, such as, for example, LYSO and LuAG:Pr may be utilized. This signal runs through a preamplifier 206 and analog-to-digital converter (‘ADC’) 208 in turn. The signal emerging from the ADC 208 is a digital signal, which may be operated on, in turn, by various logic modules. The logic modules may include a pulse shaping module 210, a pulse detection module 212, and a pulse classification module 214, and spectra building module 216. The logic modules will have different architectures suitable for different applications and may be implemented in a variety of ways, including include fewer, more, or different modules. Here, the modules are implemented as a single a field-programmable gate array (‘FPGA’), which sends the spectra to local or remote memory or to a remote subsystem 218.

One embodiment of the invention measures the Carbon/Oxygen (C/O) ratio from the inelastic gamma rays. As would be known to those versed in the art, the inelastic gamma rays scattered at an energy of about 4.4 MeV are primarily due to carbon nuclei in the formation, while the inelastic gamma rays scattered at an energy of about 6.13 MeV are indicative of oxygen nuclei in the formation. These ranges are depicted by the windows 151 and 153 in FIG. 3. The inelastic gamma ray spectrum shown therein is obtained in a water filled limestone formation.

In one embodiment of the invention, the observed spectra are fit by a weighted combination of standard spectra (e.g., Carbon and Oxygen). The weights give the relative abundance of Carbon and Oxygen (the C/O ratio). Such an approach has been discussed, for example, in U.S. Pat. No. 3,521,064 to Moran et al., the disclosure of which is hereby incorporated by reference in its entirety. In another embodiment of the invention, a window base technique is used in which the C/O ratio is given by the ratio of the counts in the windows such as 151 and 153.

Prior art methods, such as those described in U.S. Pat. No. 5,045,693 to McKeon et al., the disclosure of which is hereby incorporated by reference in its entirety, determine the C/O ratio for different detectors and then correct for the effect of the borehole fluid to determine formation properties. Specifically, McKeon teaches the determination of water saturation (or oil saturation) of the formation.

As logging conditions in the borehole become more extreme, well-logging and radioactive spectrometry have become more desirable, leading to more challenge constraints on tool design. Constraints such as limited space, low acceptable interaction count rate, and robustness in environments of high temperature, shock, and vibration are typical. Currently there is an increasing demand for gamma-ray detectors based on novel scintillation materials.

In one aspect, the present disclosure illustrates a tool with a scintillation detector specially optimized for pulsed neutron spectrometry, which may be applied to C/O logging and lithology/mineralogy logging.

An appropriate scintillation material has many of the following properties: weak dependence of the light output on temperature in the range of 60 ° C. to 175 ° C.; high energy resolution, e.g., low ‘Full Width at Half Maximum (‘TWHM’); high photo-efficiency of gamma ray detection; short scintillation decay time; high mechanical strength and resistance vibration and shock; non-hygroscopicity; low self-absorption of the scintillation light; close match between scintillation light spectrum and quantum efficiency of PMT photocathode. Based on all of these properties, the appropriate candidates enable obtaining petrophysical parameters from the measured spectra with the smallest total error.

Identification of an optimal scintillation material was carried out using a novel methodology including: performing experimental measurements of various properties of scintillators; conducting computer simulations of the detector response to gamma rays of different energies; and performing statistical analysis of error propagation (e.g. standard deviation) with the variation of measurement conditions.

Table 1 shows the results of experimental studies of scintillation materials conducted to determine the effect of various factors on detection efficiency and energy resolution of various scintillation materials. Data for NaI(Tl ) and BGO scintillators are presented for comparison. Gamma ray detection efficiency (total efficiency and photo-efficiency) increases with both scintillator density and effective atomic number. In many applications, a density of 6.7 g/cm³ may be a lower threshold.

| | | Effective | | | Peak | |
|---|---|---|---|---|---|---|
| | Density | atomic | Light Yield | Decay time | emission | |
| Scintillator | [g/cm³] | number Z_{eff} | [photons/keV] | [ns] | [nm] | Hygroscopic |
| Nal(Tl) | 3.67 | 51 | 38 | 250 | 415 | yes |
| LaCl₃ | 3.85 | 50 | 49 | 28 | 350 | yes |
| LaBr₃:Ce | 5.08 | 47 | 63 | 16 | 380 | yes |
| CeBr₃ | 5.10 | 46 | 60 | 19 | 380 | yes |
| YAP:Ce | 5.37 | 31 | 25 | 25 | 370 | no |
| (YAlO₃:Ce) | | | | | | |
| LPS | 6.23 | 64 | 26 | 38 | 385 | no |
| (Lu₂Si₂O_{7:}Ce) | | | | | | |
| GYSO | 6.7 | 59 | 9 | 45 | 440 | no |
| (Gd₂Y₂SiO₅:Ce) | | | | | | |
| LuAG:Ce | 6.73 | 60 | 20 | 60 | 535 | no |
| (Lu₃Al₅O₁₂:Ce) | | | | | | |
| LuAG:Pr | 6.73 | 60 | 19 | 20 | 315 | no |
| (Lu₃Al₅O₁₂:Pr) | | | | | | |
| LYSO | 7.1 | 65 | 32 | 41 | 420 | no |
| (LU_{1.8}Y_{0.2}SiO₅:Ce) | | | | | | |
| BGO | 7.13 | 74 | 9 | 300 | 480 | no |
| (Bi₄Ge₃O₁₂) | | | | | | |
| LuYAP:Ce | 8.34 | 65 | 11 | 18 | 365 | no |
| (Lu_{0.7}Y_{0.3}AlO₃:Ce) | | | | | | |

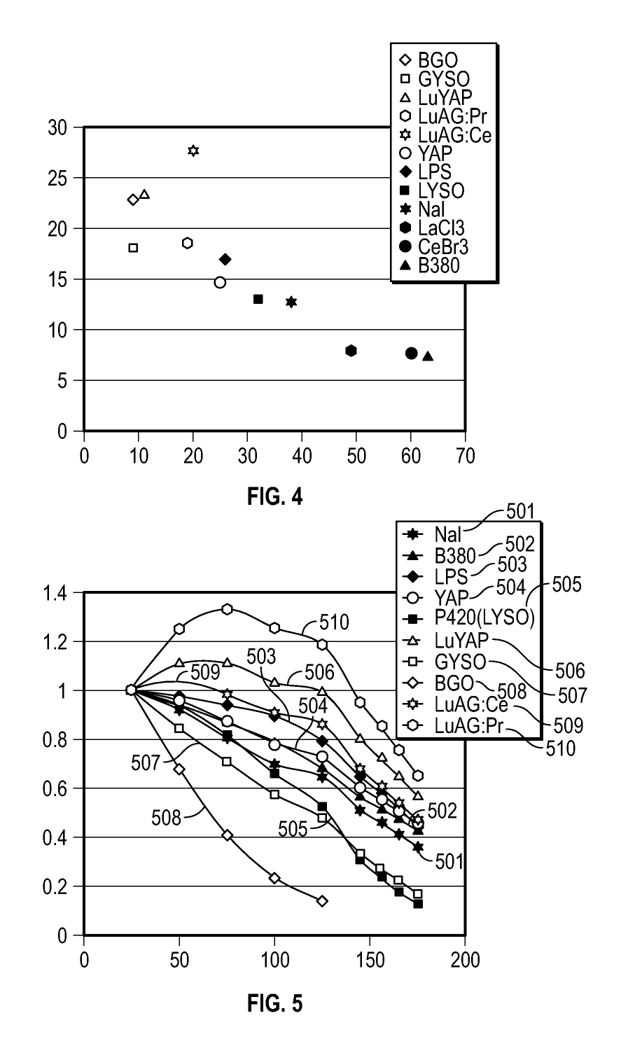

FIG. 4 is a graphical representation of scintillator energy resolution with respect to light yield. Pulse height resolution at Cs-137 662 keV line is plotted as a function of pulse height measured with laboratory PMT at room temperature. As shown, scintillator energy resolution and light yield (LY) have an inverse relationship—the higher LY, the lower is energy resolution of the particular scintillator. The highest LY of those crystals shown here, at approximately 63 photons/keV (and, thus, lowest energy resolution), is LaBr3:Ce, which is available commercially as BrilLanCe380 or B380 from Saint-Gobain Crystals of Paris, France. In addition to excellent energy resolution, LaBr3:Ce has outstanding temperature properties. It is also a very fast scintillator, having a scintillation decay time of only 16 ns. Although it has properties suitable for many applications, its low density (5.08 g/cm³) and effective charge (47) are less than optimal for neutron spectrometry, because of the relative insensitivity to high energy gamma rays as compared to more heavy scintillators (e.g., density above 7 g/cm³).

As described briefly above, BGO (Bi₄Ge₃O₁₂) and NaI(Tl) have lower LY and worse energy resolution than that of LaBr3:Ce. The LY of BGO per keV of deposited energy (˜9 photons/keV), in particular, has relegated its use mainly to high energy incident particles, despite a density of 7.13 g/cm³ and effective atomic number of 74. When measuring gamma rays with energies of just few MeV downhole, BGO struggles to provide reasonable LY and provides insufficient energy resolution for use in spectrometric tools at temperatures above 100 degrees Celsius.

NaI(Tl), one of the oldest known and most widely used scintillator, has sufficient energy resolution due to high light output (˜38 photons/keV), but a density of only 3.67 g/cm³ and effective charge of 51. Long scintillation decay time (300 ns for BGO and 230 ns for NaI(Tl)) is also detrimental, because it limits the maximum achievable count rate of the data acquisition system compared to newer scintillators having decay times in the range of 16-40 ns.

FIG. 5 shows relative pulse height for each measured detector with respect to environmental temperature. The data for FIG. 5 was obtained by subjecting detectors comprising a scintillator and the detector PMT to a range of temperatures using an oven and measuring detector performance.

For spectrometric tools, scintillator materials having lower energy resolution and sufficient independence from ambient temperature are highly desirable. Energy resolution of detectors using the candidate materials above was measured in the temperature range of 25 degrees Celsius to 175 degrees Celsius. Referring to FIGS. 5 & 6, it may be concluded that detectors with LuAG:Pr, LuYAP and LPS crystals exhibit reasonably good temperature dependence. For instance, up to 125 degrees Celcius, pulse height for the detector with LuAG:Pr (510) exceeds that at room temperature. These are heavy crystals with the heavy element Lu (which has radioactive isotope ¹⁷⁶Lu at approximately 2.5 percent concentration in natural Lu) in their structure, and thus have high efficiency to gamma rays.

YAP, LaBr³:Ce and NaI:Tl are lighter scintillators. The YAP:Ce scintillator has a density of 5.37 g/cm³ which is slightly above LaBr³:Ce, similar decay time of 25 ns, but because of a lower LY of approximately 25 photons/keV has an energy resolution similar to NaI(Tl). Also that scintillator has the lowest effective charge of the crystals examined above. The largest drop in pulse height with temperature is demonstrated by BGO.

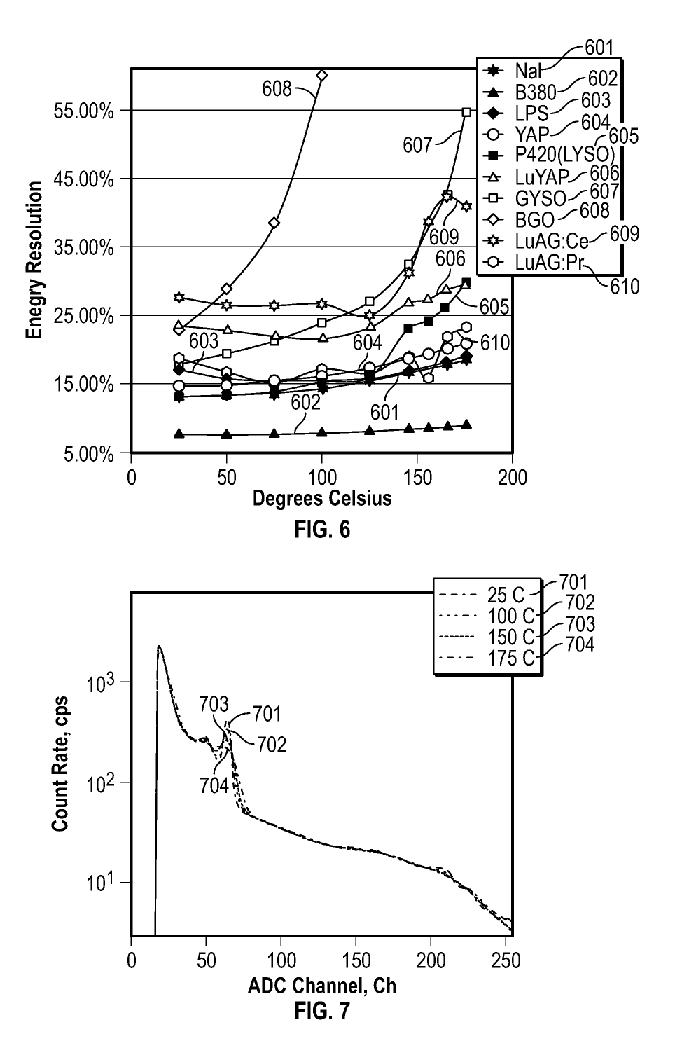

FIG. 6 shows energy resolution dependence on environmental temperature for detectors with various scintillators. It should be noted that again BGO has insufficient energy resolution at 125 Celsius of approximately 70 percent. At higher temperatures, the BGO spectra do not show any detectable peak at the ¹³⁷Cs line.

The best energy resolutions and temperature dependences among the candidate materials correspond to LaBr³:Ce, NaI:Tl, and YAP, each of which is a light scintillator. It was not possible to measure scintillators LaC1³:Ce (or B350) and CeBr³ at temperatures above 75 ° C. as they came in housings not compatible with high temperatures, but it is known that B350 is lighter than LaBr³:Ce (3.85 g/cm3 and Zeff=49) and has slightly greater temperature dependence than LaBr³:Ce. CeBr³ is a promising scintillator with properties similar to LaBr³:Ce, with lower internal radioactivity but still limited availability. Its decay time is 19 ns.

LuYaP, LPS, LYSO and LuAG:Pr are each heavy scintillators. LuYaP may be a scintillator of limited commercial availability having the lowest temperature dependence, but its LY is insufficient (˜20 photons/keV), and hence its energy resolution is insufficient in the entirety of the temperature range: 23 to 29 percent. It should be noted that energy resolution for all the scintillators was measured with a ruggedized PMT and thus lowered absolute numbers lower than those found in literature, where measurements usually are made with superior room temperature spectrometric PMTs.

LPS is another scintillator of limited commercial availability having nearly stable performance in all of the temperature range with an energy resolution of 16 to 20 percent.

LYSO (available commercially under the brand name P420 from Saint-Gobain Crystals) showed energy resolution in the range of 13 to 29 percent, including a resolution of 16.2 percent at 125 degrees Celsius and 29.5 percent at 175 degrees Celsius. It has the same resolution at 175 degrees Celsius that BGO has at 75 degrees Celsius. It also has roughly the same density as BGO, while displaying a significantly faster decay time of 40 ns. It is not hygroscopic and requires relatively little housing.

FIG. 7 illustrates energy spectra measured with one-inch diameter, six-inch long LYSO crystal in a synthetic formation irradiated with PNG for different ambient temperatures. The strong self-radioactivity of LYSO is challenging—it is reported by Saint-Gobain Crystals to be 39 counts per second per gram. However, results of modeling a P420 crystal with size 2″×4″ for typical mineralogy type measurements estimate random coincidences at the level of approximately 1 percent. Further, self-radioactivity is confined to energies below 1 MeV, and thus may be filtered using a cut-off threshold or other predefined algorithms.

LuAG:Pr has a generally flat temperature dependence and a high density (94 percent of BGO), fast decay time of approximately 20 ns and a reasonable energy resolution in wide range of temperatures. At low temperatures it is slightly lower than LYSO, but with higher temperatures, resolution of LuAG:Pr improves and matches that of LYSO at 125 degrees Celsius. As a result of the described measurements, the most promising scintillation materials available commercially are LYSO and LuAG:Pr.

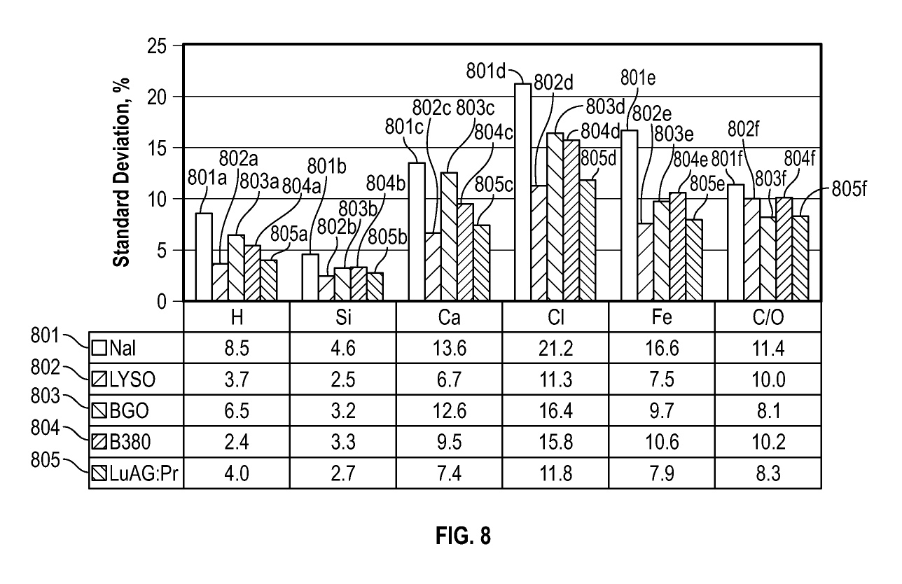

FIGS. 8-13 illustrate results from Monte Carlo simulations of detector responses of scintillation detectors comprising the candidate scintillation materials of various dimensions. In practice, it is very difficult to carry out experimental measurements of similar tools with detectors of different geometrical dimensions. It is also difficult to obtain gamma ray spectra from sources in a wide range of energies, from 0.5 MeV to 8 MeV and in different formations. Monte-Carlo simulations were used to model the performance of a variety of tools.

The GEANT-4 Monte Carlo package (developed at CERN) was used in the simulations employing the following technique. Five gamma ray lines representing radiative neutron capture characteristic energies of the chemical elements H, Si, Ca, Cl, Fe, along with two gamma ray lines representing inelastic scattering characteristic energies of elements C and O were used as sources of gamma rays (the gamma ray energy for oxygen was 6.13 MeV and for carbon was 4.44 MeV). These elements are ubiquitous rock-forming elements and their total energy spectrum of gamma rays spans a wide range. Limestone rock with zero porosity was selected as an intermediate medium between the gamma-ray source and detector. This medium is responsible for formation of the Compton-scattered gamma rays and for attenuation.

For each chemical element a standard energy spectrum with suitable statistics was simulated. A total spectra with low statistics from all sources was then simulated separately for the reactions of radiative capture and inelastic scattering. Total spectra was obtained by randomization of counts in each channel of the spectrum with the Poisson distribution as √N, where N is the number of detected gamma rays in the channel. The number of gamma rays produced from each source type was the same, resulting in a similar concentration of simulated sources (elements). For statistical evaluations, 1000 total spectra were obtained (each with poor statistics). These spectra were decomposed into the standard spectra and standard deviations from the true value were estimated. For radiative capture spectra, standard deviation from the element content was estimated. For inelastic scattering spectra, estimation of standard deviation from the C/O parameter was calculated.

The procedure was carried out for detectors featuring combinations of five cylindrical scintillators (NaI, LaBr3:Ce, LYSO, BGO, LuAG:Pr) 6 inches in length and having diameters of 1, 2, and 3 inches. The detector dimensions comport with dimensions typically used in spectrometric tools. Spectra were obtained for the temperatures of 100 ° C. and 175 ° C., with experimentally measured energy resolutions at these temperatures. For statistical evaluation, decomposition used total spectra and standard spectra, both obtained at the same temperature.

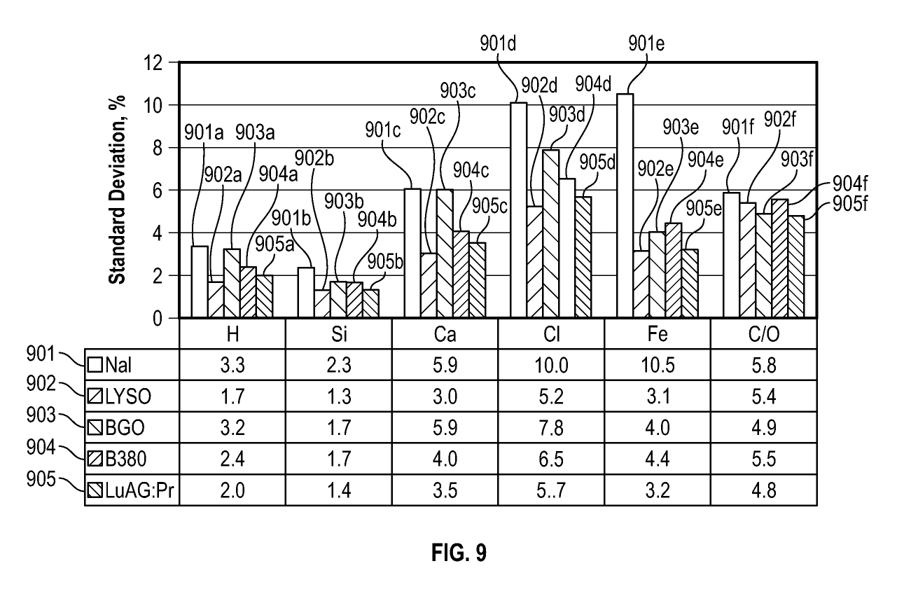

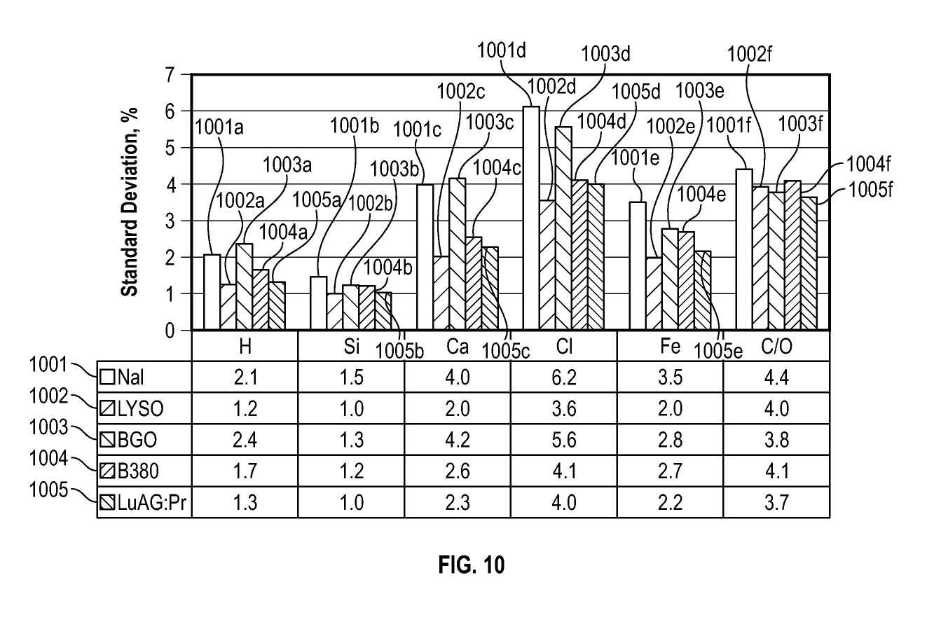

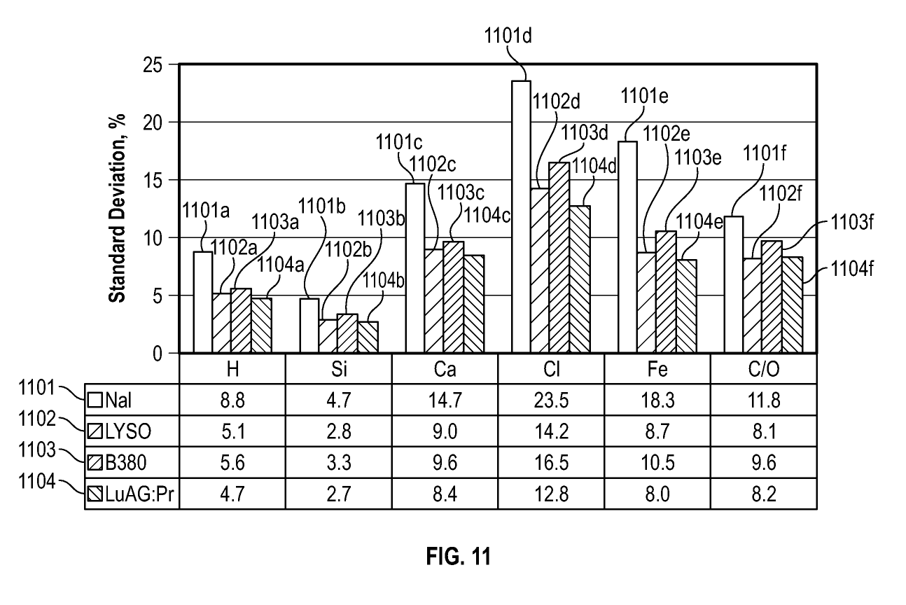

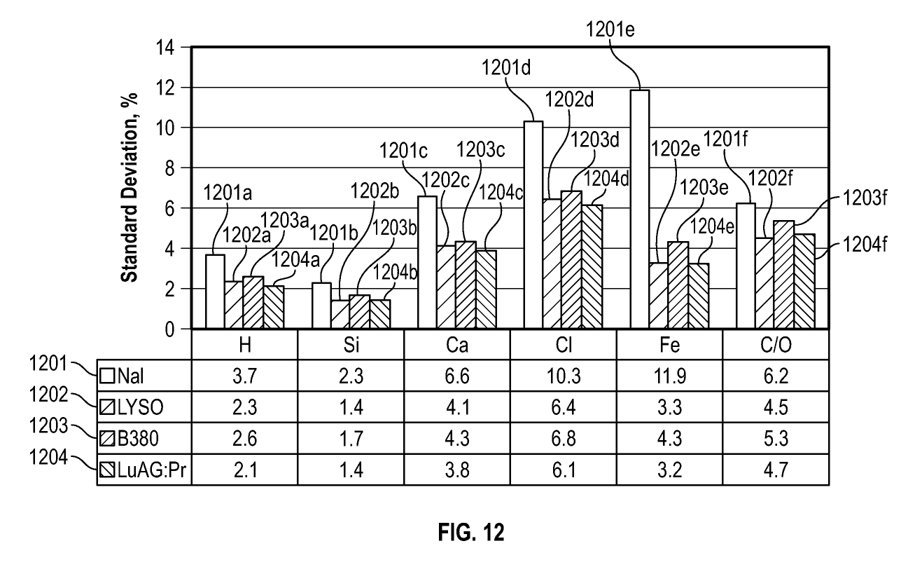

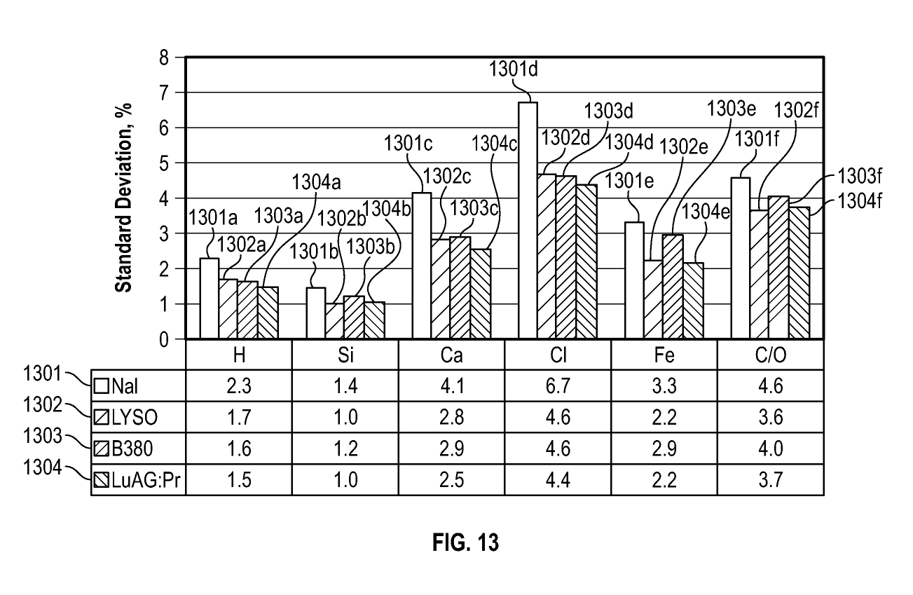

FIG. 8 shows a standard deviation in various element concentrations for detectors having one-inch diameters at a temperature of 100 Celsius. FIG. 9 shows a standard deviation in various element concentrations for detectors having two-inch diameters at a temperature of 100 Celsius. FIG. 10 shows a standard deviation in various element concentrations for detectors having three-inch diameters at a temperature of 100 Celsius. FIG. 11 shows a standard deviation in various element concentrations for detectors having one-inch diameters at a temperature of 175 Celsius. FIG. 12 shows a standard deviation in various element concentrations for detectors having two-inch diameters at a temperature of 175 Celsius. FIG. 13 shows a standard deviation in various element concentrations for detectors having three-inch diameters at a temperature of 175 Celsius.

For each of FIGS. 8-10 , the measurements for each spectra (H, Si, Ca, Cl, Fe, and C/O ratio using gamma ray lines for 6.13 MeV and 4.44 MeV) using the materials NaI (801, 901, 1001), B380 (804, 904, 1004), LYSO (802, 902, 1002), BGO (803, 903, 1003), and LuAG:Pr (805, 905, 1005) are shown. The various measurements for each material are designated with a subsequent letter. For example, referring to FIG. 8, the measurements of the hydrogen spectra for each material are designated 801a, 802a, 803a, 804a, and 805a, respectively, while the measurements of the silicon spectra for each material are designated 801b, 802b, 803b, 804b, and 805b, respectively, and so on. FIGS. 11-13 are presented similarly, but BGO measurements are not shown.

Analysis of the obtained data shows that the standard deviation for the elements Ca and Cl is higher than for H, Si and Fe. This may be due to characteristic gamma peaks in the energy spectra of some elements being located close to those of other elements. Often a peak in the spectra from one element is burdened by single or double escape peaks from another element.

Analysis also shows that for scintillators with low density, increase in the diameter of the detector significantly reduces the standard deviation. For example, change in the diameter of NaI detector from 1″ to 2″ decreases the standard deviation approximately two times. And change of detector diameter from 2″ to 3″ reduces the standard deviation approximately 1.5 times. This holds true for other scintillators with higher densities.

From the Monte Carlo analysis, it may be concluded that LYSO and LuAG:Pr show advantages over light scintillators NaI and LaBr3:Ce up to 175 ° C. for scintillator crystals with a diameter of two inches or less. The practical temperature range of LYSO is limited to 150 degrees Celsius, and may further limited by individual resolution of a particular crystal and/or PMT quality. At high temperatures, LYSO crystals having greater energy resolution degradation with increasing temperature show reduced peak selectivity compared to LaBr3:Ce, but only at low energies (e.g., around the Hydrogen peak). LYSO still outperforms LaBr3:Ce at higher energies for both individual peaks and C/O measurements.

### Substantial Instrinsic Radioactivity

Neutron activation of NaI, LaBr3:Ce and LYSO under borehole conditions was measured with a pulsed neutron generator (PNG) producing 14.1 MeV neutrons with an output of approximately 10⁸ neutrons per second. Neutrons were partially thermalized with moderating media placed between the detector and the PNG. The distance between the PNG and the scintillation detector was configured to correspond to the distance of a short-spaced detector in downhole tools. Crystals of dimensions 18mm by 60mm were irradiated with neutrons for four hours and then activation gamma spectra in the range from 0 to 3 MeV were measured continuously for 72 hours. Total counts from all crystals after the end of irradiation were approximately same, at the level of 60 -70 kcps.

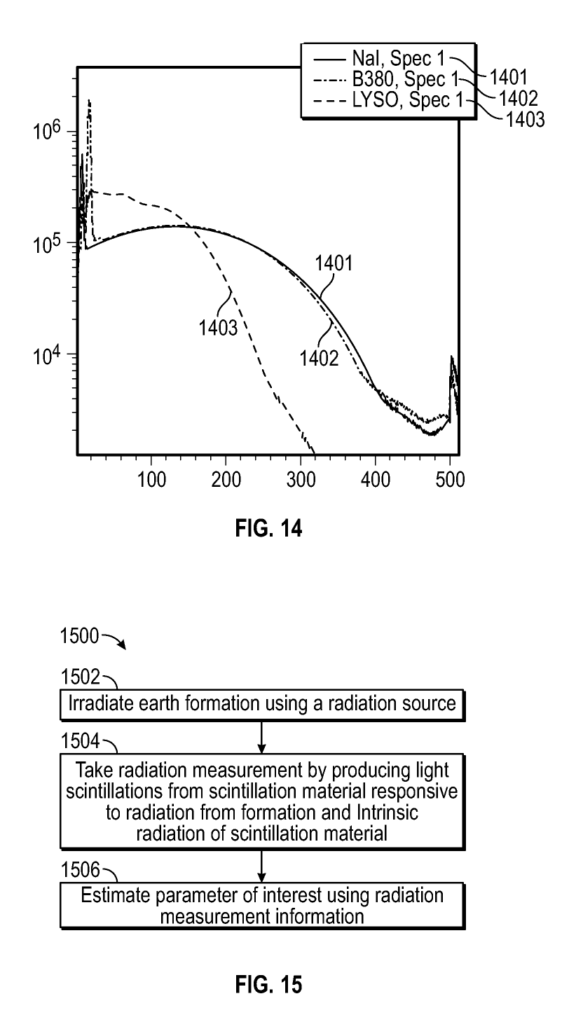

FIG. 14 shows the spectral distribution irradiated crystals in accordance with embodiment of the present disclosure. LYSO activation gamma rays are softer than those from NaI and LaBr3:Ce crystals. It should be noted that LYSO has oxygen in its structure, resulting in some oxygen activation in the crystal (having characteristic gamma energy of 6.13 MeV and decay time 7.13 seconds). Measured count rates from activation were found to be limited to a few percent of total count rates for short spaced detectors from downhole logging tools using a pulse neutron generator for all three crystals. Counts from activation measured immediately after the end of irradiation can be suppressed up to ten times with neutron shielding placed around the scintillators. After 72 hours without activation, count rates decline as much as 300 times for NaI, 70 times for LaBr3:Ce and 12 times for LYSO. Neutron shielding around the crystals increase suppression of count rates in B380 and LYSO crystals even more up to 150 and 50 times, respectively. LuAG:Pr crystal behavior under neutron activation is estimated to be very close to that of LYSO, as the crystals exhibit a similar chemical structure. LYSO and LuAG:P also have the most intensity of internal radiation between candidate scintillator materials (4000 counts/second for 18 ×60 mm LYSO).

The measurements confirm the perception that LYSO and LuAG:Pr crystals are not suitable for downhole measurements which have low level count rates such as natural gamma measurements or measurements with detectors placed far away from a neutron generator. LaBr₃:Ce crystal also exhibits internal radioactivity that interferes with the gamma ray line of interest for natural gamma ray measurements.

However, for measurements responsive to irradiation by a pulsed neutron generator (PNG), LYSO and LuAG:Pr crystals are optimal. PNGs may be utilized in Carbon-Oxygen ratio measurements, oxygen activation measurements, Sigma measurements, lithological spectroscopic measurements, mineralogical spectroscopic measurements, and so on. For these measurements, the high count rates for detectors placed in proximity to the PNG (such as SS and LS detectors) are typical. For example, these count rates may be as high as hundreds of thousands to millions of counts per second per detector, which is sufficiently greater than count rates from intrinsic radiation (internal radioactivity and neutron activation gamma rays) from these materials to treat the intrinsic counts as noise. Thus, for some high count rate measurements (for instance, sigma measurements), LYSO and LuAG:Pr crystals can be used in SS and LS positions as long as their combined background radiation from intrinsic radiation is negligible compared to the total count rates occurred from formation. These measurements also commonly use information from both the soft and hard part of the gamma spectra.

Additionally, because LYSO and LuAG:Pr have intrinsic radiation of reasonably low energies (e.g., less than 2 MeV), they do not inhibit measurements in which detection of higher gamma energies is required—such as C/O, oxygen activation measurements, and most mineralogy measurements. So LYSO and LuAG:Pr may be successfully applied in many downhole applications.

FIG. 15 shows a flow chart 1500 for estimating at least one parameter of interest of the earth formation according to one embodiment of the present disclosure. Optional step 1510 may include irradiating the earth formation using a radiation source to provoke radiation from the formation responsive to the irradiation. This may be carried out by turning on a neutron source to expose at least part of the earth formation 80 to neutron radiation. Interaction with the nuclear radiation emissions and the earth formation 80 may result a nuclear radiation response from the earth formation (see FIG. 1B).

In step 1520, a radiation measurement is taken using a detector including a scintillation material having substantial intrinsic radiation. The scintillation material may comprise at least one of: i) Lu₃Al₅O₁₂:Pr (LuAG:Pr), and ii) Lu₂₍₁₋ₓ₎Y₂SiO₅:Ce (LYSO). Taking the radiation measurement may include generating radiation measurement information by producing light scintillations from the scintillation material responsive to the absorption by the scintillation material of the radiation from the formation and intrinsic radiation of the scintillation material. The scintillation material may be a lutetium-based scintillation material having substantial intrinsic radiation.

In step 1530, a parameter of interest of the formation may be estimated using radiation measurement information. As described above in greater detail, estimating the parameter of interest may include deriving a response spectrum from the radiation measurement information and using the response spectrum to estimate the parameter of interest. Some implementations may include modifying the radiation measurement information using a correction heuristic, wherein the correction heuristic is independent of the portion of the radiation measurement information attributable to intrinsic radiation of the scintillation material. For example, particular energy windows may be extracted and used for estimating the parameter, a correction standard may be applied to the response spectrum, or the like. In some examples, irradiating the earth formation results in oxygen activation, and the radiation measurement information is indicative of oxygen activation.

The at least one parameter of interest may include, but is not limited to, one or more of: (i) a lithology characterization; (ii) a mineralogical composition; (iii) a carbon-oxygen ratio; (iv) neutron capture cross-section of the formation; (v) a sourceless gamma density estimate. When estimating the parameter of interest, the radiation measurement information may be non-adjusted, or it may be modified using a correction heuristic, wherein the correction heuristic is predetermined prior to the taking of the radiation measurement.

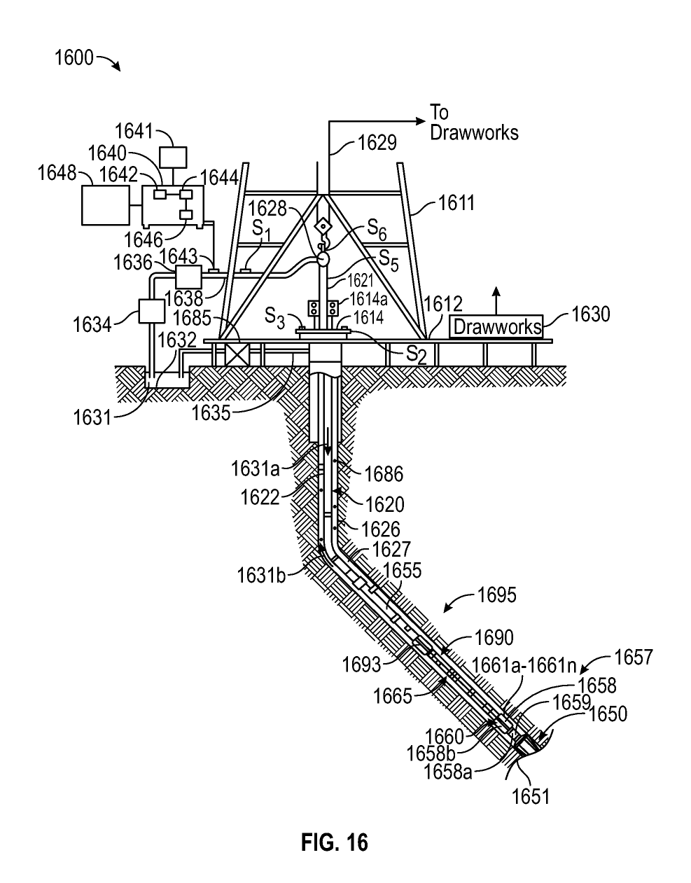

Each of the embodiments herein may be used in a variety of settings in both drilling and non-drilling environments. In some implementations, the disclosed embodiments may be used as part of a drilling system. FIG. 16 is a schematic diagram of an example drilling system 100 that includes a drill string having a drilling assembly attached to its bottom end that includes a steering unit according to one embodiment of the disclosure. FIG. 16 shows a drill string 1620 that includes a drilling assembly or bottomhole assembly (BHA) 1690 conveyed in a borehole 1626. The drilling system 100 includes a conventional derrick 1611 erected on a platform or floor 1612 which supports a rotary table 1614 that is rotated by a prime mover, such as an electric motor (not shown), at a desired rotational speed. A tubing (such as jointed drill pipe 1622), having the drilling assembly 1690, attached at its bottom end extends from the surface to the bottom 1651 of the borehole 1626. A drill bit 1650, attached to drilling assembly 1690, disintegrates the geological formations when it is rotated to drill the borehole 1626. The drill string 1620 is coupled to a drawworks 1630 via a Kelly joint 1621, swivel 1628 and line 1629 through a pulley. Drawworks 1630 is operated to control the weight on bit (“WOB”). The drill string 1620 may be rotated by a top drive (not shown) instead of by the prime mover and the rotary table 1614. Alternatively, a coiled-tubing may be used as the tubing 1622. A tubing injector 1614a may be used to convey the coiled-tubing having the drilling assembly attached to its bottom end. The operations of the drawworks 1630 and the tubing injector 114a are known in the art and are thus not described in detail herein.

A suitable drilling fluid 1631 (also referred to as the “mud”) from a source 1632 thereof, such as a mud pit, is circulated under pressure through the drill string 1620 by a mud pump 1634. The drilling fluid 1631 passes from the mud pump 1634 into the drill string 1620 via a desurger 1636 and the fluid line 1638. The drilling fluid 1631a from the drilling tubular discharges at the borehole bottom 1651 through openings in the drill bit 1650. The returning drilling fluid 1631b circulates uphole through the annular space 1627 between the drill string 1620 and the borehole 1626 and returns to the mud pit 1632 via a return line 1635 and drill cutting screen 1685 that removes the drill cuttings 1686 from the returning drilling fluid 1631b. A sensor Sᵢ in line 1638 provides information about the fluid flow rate. A surface torque sensor S₂ and a sensor S₃ associated with the drill string 1620 respectively provide information about the torque and the rotational speed of the drill string 1620. Tubing injection speed is determined from the sensor S₅, while the sensor S₆ provides the hook load of the drill string 1620.

In some applications, the drill bit 1650 is rotated by only rotating the drill pipe 1622. However, in many other applications, a downhole motor 1655 (mud motor) disposed in the drilling assembly 1690 also rotates the drill bit 1650. The rate of penetration (ROP) for a given BHA largely depends on the WOB or the thrust force on the drill bit 1650 and its rotational speed.

The mud motor 1655 is coupled to the drill bit 1650 via a drive shaft disposed in a bearing assembly 1657. The mud motor 1655 rotates the drill bit 1650 when the drilling fluid 1631 passes through the mud motor 1655 under pressure. The bearing assembly 157, in one aspect, supports the radial and axial forces of the drill bit 1650, the down-thrust of the mud motor 1655 and the reactive upward loading from the applied weight-on-bit.

A surface control unit or controller 1640 receives signals from the downhole sensors and devices and signals from sensors S₁-S₆ and other sensors used in the system 1600 and processes such signals according to programmed instructions provided to the surface control unit 1640. The surface control unit 1640 displays desired drilling parameters and other information on a display/monitor 1641 that is utilized by an operator to control the drilling operations. The surface control unit 1640 may be a computer-based unit that may include a processor 1642 (such as a microprocessor), a storage device 1644, such as a solid-state memory, tape or hard disc, and one or more computer programs 1646 in the storage device 1644 that are accessible to the processor 1642 for executing instructions contained in such programs. The surface control unit 1640 may further communicate with a remote control unit 1648. The surface control unit 1640 may process data relating to the drilling operations, data from the sensors and devices on the surface, data received from downhole, and may control one or more operations of the downhole and surface devices. The data may be transmitted in analog or digital form.

The BHA 1690 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the formation 1695 surrounding the BHA 1690. Such sensors are generally known in the art and for convenience are generally denoted herein by numeral 1665. The BHA 1690 may further include a variety of other sensors and devices 1659 for determining one or more properties of the BHA 1690 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 1659.

The BHA 1690 may include a steering apparatus or tool 1658 for steering the drill bit 1650 along a desired drilling path. In one aspect, the steering apparatus may include a steering unit 1660, having a number of force application members 1661a-1661n, wherein the steering unit is at partially integrated into the drilling motor. In another embodiment the steering apparatus may include a steering unit 1658 having a bent sub and a first steering device 1658a to orient the bent sub in the wellbore and the second steering device 1658b to maintain the bent sub along a selected drilling direction.

The drilling system 1600 may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling, and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED.

The drilling system 100 can include one or more downhole processors at a suitable location such as 193 on the BHA 190. The processor(s) can be a microprocessor that uses a computer program implemented on a suitable non-transitory computer-readable medium that enables the processor to perform the control and processing. The non-transitory computer-readable medium may include one or more ROMs, EPROMs, EAROMs, EEPROMs, Flash Memories, RAMs, Hard Drives and/or Optical disks. Other equipment such as power and data buses, power supplies, and the like will be apparent to one skilled in the art. A point of novelty of the system illustrated in FIG. 16 is that the surface processor 1642 and/or the downhole processor 1693 are configured to perform certain methods (discussed below) that are not in prior art.

Methods of the present disclosure may include determining the concentration in the system (e.g., the formation and borehole fluid) of significant nuclides such as, for example, oxygen and carbon. This may be carried out using a neutron induced gamma ray mineralogy measurement obtained along with the density measurement system. The same can also be achieved by measuring sourceless density and using an existing mineralogy log from a previous logging run. In both cases, it is possible to estimate a total oxygen concentration and a total carbon concentration in the system. Since the oxygen and carbon amount is linearly correlated with the gamma ray source to be used for density measurements, the oxygen, carbon and amy other relevant element concentration measurement may be used to normalize the gamma ray source. The methods herein may occur in real-time using a tool that has both density and neutron induced gamma mineralogy systems on board. Alternatively, a sourceless density log may be processed subsequent to the logging run with mineralogy data sufficient to estimate oxygen, carbon and any other relevant element contents for normalizing the gamma ray source. Either embodiment enables removal of all other variables from the measurement except the formation density.

“Spectrometric” refers to measurement of a spectrum of gamma rays emitted by a formation. The formation may be bombarded by high-energy neutrons to induce this emission of gamma rays. Neutrons emitted by a pulsed neutron generator may interact with different nuclei, which may emit characteristic gamma rays through inelastic neutron scattering, fast-neutron reactions, neutron capture, and so on. Inelastic and fast-neutron interactions occur very soon after the neutron burst, while most of the capture events occur later, so it is possible to separate the different interactions in time after each neutron pulse (e.g., into an ‘inelastic’ spectrum and a ‘capture’ spectrum). Spectra may be analyzed, such as, for example, by counting gamma rays in energy windows, deconvolution of the spectral response curve, or by comparison with spectral standards.

An “interaction” may be described as an event causing a change in energy and direction of incident radiation (e.g., a gamma ray) prior to measurement of the radiation and absorption of the radiation. An “interaction” may induce emission of secondary radiation as well (e.g. emission of a secondary neutron and/or gamma ray). The term “absorb” refers to absorption in the sense of converting ionizing radiation, such as, for example, neutrons or gamma rays, to other detectable indicia, such as, for example, photons. Intrinsic radiation refers to internal radioactivity and neutron activation gamma rays of a scintillation material. “Substantial intrinsic radiation” as used herein refers to an amount of radiation, due to properties of a scintillation material, that are attributable to the intrinsic radiation of the scintillation material, that amount of radiation producing at least 100 scintillations from the material per second per cubic centimeter of the material downhole.

Herein, the term “information” may include, but is not limited to, one or more of: (i) raw data, (ii) processed data, and (iii) signals. The term “conveyance device” as used above means any device, device component, combination of devices, media and/or member that may be used to convey, house, support or otherwise facilitate the use of another device, device component, combination of devices, media and/or member. Exemplary non-limiting conveyance devices include drill strings of the coiled tube type, of the jointed pipe type and any combination or portion thereof. Other conveyance device examples include casing pipes, wirelines, wire line sondes, slickline sondes, drop shots, downhole subs, BHA's, drill string inserts, modules, internal housings and substrate portions thereof, self-propelled tractors. As used above, the term “sub” refers to any structure that is configured to partially enclose, completely enclose, house, or support a device. The term “information” as used above includes any form of information (Analog, digital, EM, printed, etc.). The term “processor” herein includes, but is not limited to, any device that transmits, receives, manipulates, converts, calculates, modulates, transposes, carries, stores or otherwise utilizes information. An information processing device may include a microprocessor, resident memory, and peripherals for executing programmed instructions. The “correction heuristic” may include application of a scalar quantity, matrix, or curve mathematically applied (e.g., addition, subtraction, multiplication, pointwise summation, etc.) to the radiation information, or the use of only radiation window corresponding to one or more particular energy windows.

While the foregoing disclosure is directed to the one mode embodiments of the disclosure, various modifications will be apparent to those skilled in the art. It is intended that all variations be embraced by the foregoing disclosure.

What is claimed is:

1. A method of evaluating an earth formation intersected by a borehole, the method comprising:
irradiating the earth formation using a radiation source to provoke radiation from the formation responsive to the irradiation;
taking a radiation measurement and thereby generating radiation measurement information by producing light scintillations from a scintillation material responsive to the absorption by the scintillation material of the radiation from the formation and intrinsic radiation of the scintillation material, the scintillation material comprising at least one of: i) Lu₃Al₅O₁₂:Pr (LuAG:Pr), and ii) Lu₂₍₁₋ₓ₎Y₂SiO₅:Ce (LYSO);
estimating a parameter of interest of the earth formation using the radiation measurement information.

2. The method of claim 1 wherein the radiation measurement information is non-adjusted.

3. The method of claim 1 wherein the radiation measurement information is modified using a correction heuristic, and the correction heuristic is predetermined prior to the taking of the radiation measurement.

4. The method of claim 1 wherein irradiating the earth formation further comprises using a pulsed neutron source.

5. The method of claim 1 wherein measuring the radiation further comprises measuring gamma rays resulting from the irradiation.

6. The method of claim 1 comprising deriving a response spectrum from the radiation measurement information and using the response spectrum to estimate the parameter of interest.

7. The method of claim 1 wherein the parameter of interest comprises at least one of: (i) a lithology characterization; (ii) a mineralogical composition; (iii) a carbon-oxygen ratio; (iv) neutron capture cross-section of the formation; (v) a sourceless gamma density estimate.

8. The method of claim 1 wherein irradiating the earth formation results in oxygen activation, and the radiation measurement information is indicative of oxygen activation.

9. The method of claim 1 further comprising conveying the source of radiation into the borehole on a conveyance device selected from: (i) a wireline, and (ii) a bottomhole assembly on a drilling tubular.

10. The method of claim 1 wherein the radiation measurement information is modified using a correction heuristic, and the correction heuristic is independent of the portion of the radiation measurement information attributable to intrinsic radiation of the scintillation material.

11. A method of evaluating an earth formation intersected by a borehole, the method comprising:
irradiating the earth formation using a radiation source to provoke radiation from the formation responsive to the irradiation;
taking a radiation measurement and thereby generating radiation measurement information by producing light scintillations from a lutetium-based scintillation material responsive to the absorption by the scintillation material of the radiation from the formation and intrinsic radiation of the scintillation material, wherein the intrinsic radiation of the scintillation material produces at least 100 scintillations per second per cubic centimeter of the material;
estimating a parameter of interest of the earth formation using the radiation measurement information.

12. An apparatus for evaluating an earth formation intersected by a borehole, the apparatus comprising:
a carrier configured to be conveyed in a borehole;
a radiation source associated with the carrier and configured for irradiating the earth formation to provoke radiation from the formation responsive to the irradiation;
a radiation detector associated with the carrier and configured for taking a radiation measurement in the borehole and thereby generating radiation measurement information by producing light scintillations from a scintillation material responsive to the absorption by the scintillation material of the radiation from the formation and intrinsic radiation of the scintillation material, the scintillation material comprising at least one of: i) Lu₃Al₅O₁₂:Pr (LuAG:Pr), and ii) Lu₍₁₋ₓ₎Y₂SiO₅:Ce (LYSO); and
at least one processor configured for estimating a parameter of interest of the earth formation using the radiation measurement information.
